(19) United States
(12) Patent Application Publication
(10) Pub. No.: US 2025/0042414 A1
(43) Pub. Date: Feb. 6, 2025

(54) ASSIST SYSTEM FOR A VEHICLE

(71) Applicant: GM Global Technology Operations LLC, Detroit, MI (US)

(72) Inventors: Ryan Patrick Hickey, Austin, TX (US); Russell A. Patenaude, Macomb Township, MI (US)

(73) Assignee: GM Global Technology Operations LLC, Detroit, MI (US)

(21) Appl. No.: 18/362,096

(22) Filed: Jul. 31, 2023

(51) Int. Cl. B60W 40/10; B60W 50/14; G01C 21/34

(52) U.S. Cl. CPC B60W 40/10; B60W 50/14; G01C 21/3453; B60W 2420/403; B60W 2420/408; B60W 2556/45

(57) ABSTRACT

A vehicle assist system includes an imager coupled to a vehicle body. The imager is configured to capture a vehicle environment, and a GPS processor is configured to detect a geographical location of a vehicle. The vehicle assist system also includes a controller that stores vehicle data and a coastdown procedure. The controller is communicatively coupled to the imager and the GPS processor and is configured to detect a trigger event. In response to the trigger event, the controller is configured to execute the coastdown procedure based on the vehicle data, the vehicle environment from the imager, and the geographical location of the vehicle.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against present disclosure.

The present disclosure relates generally to an assist system for a vehicle.

Vehicles utilize various navigation and telecommunication systems to route the vehicle during operation. Such systems may track the location of a vehicle and provide feedback to a driver as to the surroundings of the vehicle. Vehicles are also often equipped with a user interface that communicates information about the vehicle to the driver or other occupants. For example, the user interface may notify the driver of tire pressure changes or recommend an oil change. While conventional vehicle systems provide information to the driver, conventional systems do not typically execute actions in response to service notifications.

Other conventional systems provide communication capabilities between a telecommunication system and an outside provider. For example, a driver may use the telecommunication system to contact the outsider provider to request service to the vehicle in response to the service notification. In the event of an immediate service need, the driver may route the vehicle off of a main road to contact a service provider for assistance. The conventional telecommunication system is typically operable in response to an input from the driver or occupant but rarely operates independent of driver intervention.

### SUMMARY

In one configuration, an assist system for a vehicle includes a sensor coupled to a body of the vehicle. The sensor is configured to detect objects within an environment proximate to the vehicle. A GPS processor is configured to communicate a geographical location of the vehicle, and a controller is communicatively coupled to the sensor and the GPS processor. The controller stores vehicle data and a coastdown procedure that includes a stop position, a service positon, and a service perimeter. The controller is configured to receive a signal from the sensor corresponding to a trigger event and to execute, in response to the trigger event, the coastdown procedure based on the vehicle data. The assist system also includes a communication server that is communicatively coupled to the controller via a network. The controller is configured to send a signal to the communication server in response to the trigger event, and the communication server is configured to communicate the coast down procedure with an occupant of the vehicle.

In some aspects, the assist system may include a display device that is communicatively coupled to the controller. The controller may be configured to display the coastdown procedure on the display. The coastdown procedure may include an available coastdown range of the vehicle. In some examples, the controller may be configured to identify the trigger event as at least one of an electrical event and a mechanical event. The electrical event may include a thermal runaway event. The controller may route the vehicle to the stop position and the service position within the service perimeter. The GPS processor may store environmental information including road grade, road curvature, and building locations. The controller may be configured to adjust the coastdown procedure in response to the environmental information received from the GPS processor. Optionally, the sensor may include at least one of an imager, a proximity sensor, and a LIDAR sensor.

In another configuration, a vehicle assist system includes an imager coupled to a vehicle body. The imager is configured to capture a vehicle environment, and a GPS processor is configured to detect a geographical location of a vehicle. The vehicle assist system also includes a controller that stores vehicle data and a coastdown procedure. The controller is communicatively coupled to the imager and the GPS processor and is configured to detect a trigger event. In response to the trigger event, the controller is configured to execute the coastdown procedure based on the vehicle data, the vehicle environment from the imager, and the geographical location of the vehicle.

In some examples, the coastdown procedure may include a stop position, a service position, and a service perimeter. The controller may be configured to identify the service perimeter based on the geographical location of the vehicle and the vehicle environment. The GPS processor may store environmental information including road grade, road curvature, and building locations, and the controller may be configured to determine a coastdown range based on the environmental information from the GPS processor. The controller may be configured to update the coastdown procedure based on building locations received from the GPS processor. In some examples, the controller may be configured to receive the vehicle environment from the imager and may be configured to adjust the coastdown procedure in response to the vehicle environment. The controller may be configured to reroute the vehicle during the coastdown procedure to maximize a coastdown range in response to the road grade. In other aspects, the vehicle assist system may include a communication server that may be communicatively coupled to the controller via a network. The controller may be configured to send a signal to the communication server in response to the trigger event, and the communication server may be configured to communicate the coastdown procedure with an occupant.

In yet another configuration, an assist system for a vehicle includes an imager coupled to a body of the vehicle. The imager is configured to capture a vehicle environment, and a GPS processor is configured to detect a geographical location of the vehicle and store environmental information including road grade and road curvature. A controller is communicatively coupled to the imager and the GPS processor and is configured to determine a coastdown route and a service perimeter based on the vehicle environment received from the imager and the environmental information received from the GPS processor in response to a trigger event detected by the imager.

In some aspects, the controller may be configured to adjust the coastdown route based on sensor data from the imager and GPS data from the GPS processor. The assist system may include a service port, and the controller may be configured to define the service perimeter of the coastdown procedure based on a location of the service port. The coastdown procedure may store a service position as the service port being free from obstructions. Optionally, the trigger event may be a loss of propulsion.

### BRIEF DESCRIPTION OF THE DRAWINGS

The drawings described herein are for illustrative purposes only of selected configurations and are not intended to limit the scope of the present disclosure.

FIG. 1A is a perspective schematic view of a vehicle according to the present disclosure in communication with a network:

FIG. 1B is a partial perspective view of an interior of the vehicle of FIG. 1A with a sensor and display device according to the present disclosure;

FIG. 2 is a functional block diagram of an example assist system providing communication between a controller, a GPS processor, a sensor, and a network according to the present disclosure:

FIG. 3 is a functional block diagram of an example coastdown procedure of an assist system in communication with a GPS processor and network according to the present disclosure:

FIG. 4 is a perspective view of a vehicle positioned a predetermined distance from an obstruction according to the present disclosure:

FIG. 5 is an example method of determining a coastdown procedure according to the present disclosure:

FIG. 6 is an example method of determining a coastdown route according to the present disclosure:

FIG. 7 is an example method of determining an available coastdown range and pull-over location according to the present disclosure:

FIG. 8 is a schematic of a vehicle in a service position according to the present disclosure; and

FIG. 9 is a schematic of the vehicle of FIG. 8 positioned on a service vehicle according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising.” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below; the term module may be replaced with the term circuit. The term module may refer to, be part of, or include an Application Specific Integrated Circuit (ASIC): a digital, analog, or mixed analog/digital discrete circuit: a digital, analog, or mixed analog/digital integrated circuit: a combinational logic circuit: a field programmable gate array (FPGA): a processor (shared, dedicated, or group) that executes code: memory (shared, dedicated, or group) that stores code executed by a processor: other suitable hardware components that provide the described functionality: or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory. Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

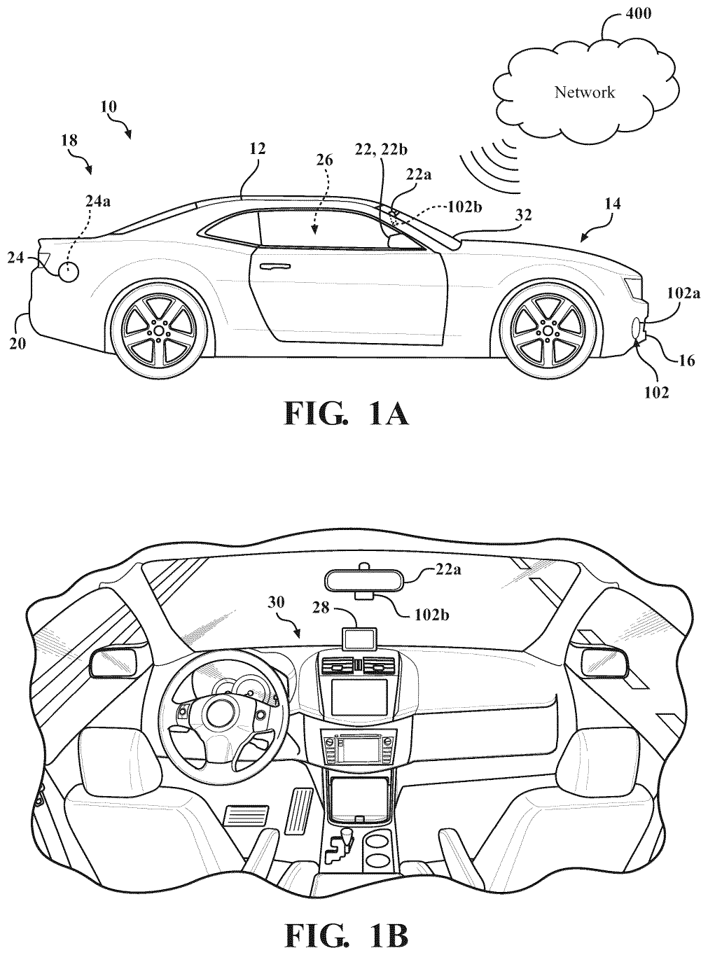

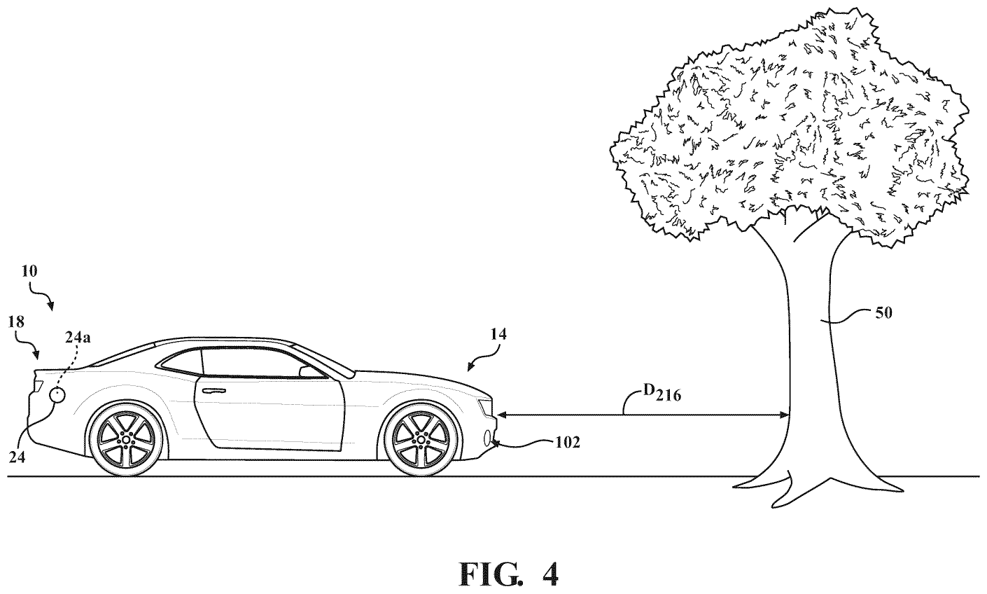

Referring to FIGS. 1A-4, a vehicle 10 includes a vehicle body 12 equipped with a vehicle assist system 100. In some aspects of the disclosure, the vehicle 10 is an electric vehicle (EV) with autonomous or semi-autonomous capabilities. Additionally or alternatively, the vehicle 10 may be configured with an internal combustion engine (ICE). In other aspects, the vehicle 10 may be a hybrid vehicle incorporating both EV and ICE components and capabilities.

The vehicle body 12 may be generally divided into a vehicle forward portion 14 proximate a front bumper 16 of the vehicle body 12 and a vehicle rearward portion 18 proximate a rear bumper 20. As depicted in FIG. 1A, the vehicle assist system 100 includes a plurality of sensors 102 that may be incorporated with various elements of the vehicle body 12 including, but not limited to, rearview mirrors 22, the front bumper 16, and the rear bumper 20. For example, a proximity sensor 102a may be positioned on the vehicle forward portion 14 to detect a distance between the vehicle 10 and an object, as described below. The sensors 102 may also include other vehicle sensors 102 including, but not limited to, light detection and ranging (LIDAR) sensors that may be incorporated as part of the vehicle body 12. The vehicle 10 also includes a service port 24 that is illustrated at the vehicle rearward portion 18 of the vehicle 10. The service port 24 may be positioned at any practicable location along the vehicle body 12 proximate the vehicle rearward portion 18 or the vehicle forward portion 14. The service port 24 may include a vent 24a utilized to service the service port 24 and the vehicle 10.

An interior 26 of the vehicle 10 is defined by the vehicle body 12 and includes an interior rearview mirror 22a and a display device 28. The interior rearview mirror 22a may be equipped with one or more of the plurality of sensors 102 including, but not limited to, an imager 102b. It is also contemplated that the imager 102b may be positioned on exterior rearview mirrors 22b. The imager 102b is configured to capture a surrounding vehicle environment, as described further below.

The display device 28 may be situated at a dashboard 30 of the vehicle 10 and is configured to display information related to the vehicle 10 to an occupant, including a driver, of the vehicle 10. In some aspects, the display device 28 may be a heads-up display (HUD) integrated with a windshield 32 of the vehicle 10. In other examples, the display device 28 may be a tablet device integrated with the dashboard 30 and configured with capacitive sensors for operative functions of the display device 28. As described in more detail below, the display device 28 may display information pertaining to the vehicle 10 to the occupant before, during, and after operation of the vehicle 10.

With further reference to FIGS. 1A-4, the vehicle assist system 100 is communicatively coupled to the display device 28 and the sensors 102. The vehicle assist system 100 is configured to interconnect a controller 200 of the vehicle 10, a GPS processor 300, and a network 400. The controller 200 may store vehicle data 202 along with sensor data 104 associated with the sensors 102. The controller 200 may also be communicatively coupled to a transmission device 40) that is communicatively coupled with the network 400 to transmit audio messages from a communication server 402. The transmission device 40 may also transmit the vehicle data 202 stored on the controller 200 with the communication server 402. The transmission device 40 may, at least in part, communicatively couple the controller 200 to the network 400 for wireless communication capabilities including, in some aspects, wireless calling and emergency communications. In some examples, the transmission device 40 is an OnStar′R system that includes operative functions including, but not limited to, in-vehicle security, emergency services, turn-by-turn navigation, and remote diagnostics, which may be executed at least in part between the controller 200 and the network 400.

The controller 200 is communicatively coupled to the GPS processor 300 via the network 400 to provide GPS data 302, such as a GPS location 304 of the vehicle 10, to the occupant. For example, the GPS data 302 may also include a surrounding geographical location 306 corresponding to a route of the vehicle 10 and environmental information 308 relative to the vehicle 10 monitored both during transit and in a stationary position. The environmental information 308 includes information including, but not limited to, road conditions, road curvatures, road grade, building locations, and topographical information. The environmental information 308 may include additional environmental information 308 related to the surroundings of the vehicle 10 that may be advantageous to transmit to the controller 200.

The GPS processor 300 transmits the geographical location 306 and the environmental information 308 over the network 400 to the controller 200. As mentioned above, the network 400 may include the communication server 402 communicatively coupled to the transmission device 40 to send and receive signals corresponding to information. For example, the communication server 402 may obtain the GPS data 302 from the GPS processor 300 and communicate the GPS data 302 directly with the occupant or driver of the vehicle 10 via the transmission device 40. In some examples, the communication server 402 may also communicate the GPS data 302 to the controller 200 for analysis as part of the assist system 100.

Referring still to FIGS. 1A-4, the vehicle data 202 stored on the controller 200 includes, in some aspects, information pertaining to a speed 204 of the vehicle 10, a mechanical condition 206 of the vehicle 10, and an electrical condition 208 of the vehicle 10. The vehicle data 202 may also include other information about the vehicle 10, such as trip information and/or, in an EV example, battery life of the vehicle 10. The controller 200 may utilize the vehicle data 202 in combination with the sensor data 104 to monitor a vehicle environment during operation of the vehicle 10 and during various vehicle procedures, described below.

The controller 200 is also configured with a coastdown procedure 210. The coastdown procedure 210 is stored on the controller 200 as part of the assist system 100 and is activated in response to a trigger event 106, described below. The assist system 100 incorporates each of the sensors 102, the controller 200, and the GPS processor 300 in executing the coastdown procedure 210 and may also incorporate the network 400 for various aspects of the coastdown procedure 210. The coastdown procedure 210 includes a variety of preset, stationary positions of the vehicle 10. For example, the coastdown procedure 210 includes a stop position 212 and a service position 214. While both the stop position 212 and the service position 214 are stationary positions of the vehicle 10, the stop position 212 and the service position 214 encompass different stationary conditions of the vehicle 10. For example, the stop position 212 is associated with a pull-over location 216 in which the vehicle 10 may be stationary irrespective of the location of the service port 24 of the vehicle 10. While the pull-over location 216 is configured to position the vehicle 10 away from surrounding traffic and pedestrians, the pull-over location 216 is utilized by the controller 200 as an immediate response to the trigger event 106 in certain circumstances described below. Thus, the position of the service port 24 may have a lower priority in the stop position 212, such that the service port 24 may be proximate an obstruction 50.

For example, the controller 200, as part of the coastdown procedure 210, may identify the pull-over location 216 for the vehicle 10 to come to a stop that removes the vehicle 10 from a flow of traffic or other generalized obstruction and place the vehicle 10 in the stop position 212. The stop position 212, while removing the vehicle 10 from a traffic environment, is utilized as an immediate or semi-immediate position for the vehicle 10 to be stationary. In determining the stop position 212, the controller 200 utilizes the GPS location 302 from the GPS processor 300 to generally identify a location for the stop position 212 and then, once the vehicle 10 arrives at the pull-over location 216, utilizes the sensors 102 to identify the exact stop position 212. While the vehicle 10 is removed from a traffic situation, the vehicle 10 may or may not be in a position for servicing the vehicle 10 based on potential surrounding obstructions 50.

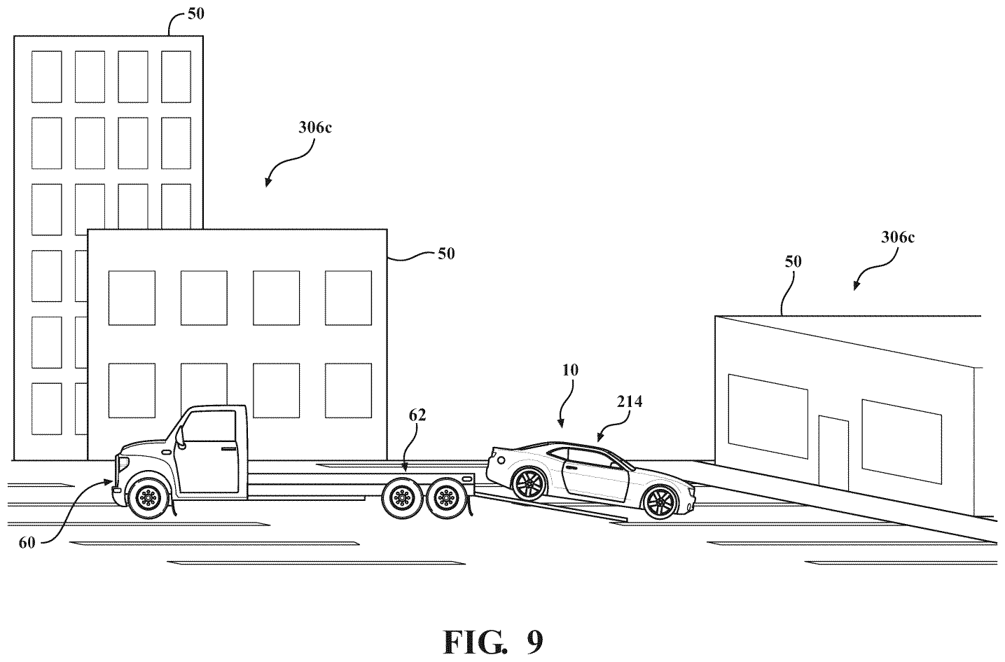

Comparatively, in determining the service position 214, the controller 200 prioritizes the accessibility of the service port 24 for service by a service responder 60 (FIG. 9). The pull-over location 216 may include a service perimeter 216a, described in more detail below. The service position 214 is defined within the service perimeter 216a and utilizes the same information used by the controller 200 in determining the stop position 212. However, once the vehicle 10 arrives at the pull-over location 216, the controller 200 uses the information from the sensors 102 to further identify an orientation of the vehicle 10 that minimizes potential obstructions 50 that might impede servicing of the vehicle 10 at the service port 24. For example, the controller 200 may rotate the orientation of the vehicle 10 to reach the service position 214, whereas the added rotational step may be skipped when positioning the vehicle 10 in the stop position 212. While the stop position 212 may or may not include the service position 214, the service position 214 includes the stop position 212 in that the vehicle 10 is in the stop position 212 when the vehicle 10 is in the service position 214.

With continued reference to FIGS. 1A-4, in determining the stop position 212 and the service position 214, the controller 200 also identifies the service perimeter 216a as part of the coastdown procedure 210. The service perimeter 216a includes an area of space in which the vehicle 10 may come to a stop and be spaced apart from obstructions 50 at the vehicle forward portion 14, the vehicle rearward portion 18, and a distance above the vehicle 10. The service perimeter 216a may also be defined as any combination of the vehicle 10 being spaced apart and free from obstructions 50, including having a predefined distance D₂₁₆ between the vehicle 10 and an obstruction 50. In some aspects, the predefined distance D₂₁₆ is approximately 50 feet from the nearest obstruction 50. However, it is also contemplated that the predefined distance D₂₁₆ may be a distance less than approximately 50 feet or greater than approximately 50 feet. While the predefined distance D₂₁₆ may be utilized by the controller 200 in defining the service perimeter 216a, the controller 200 is configured to holistically assess the vehicle environment in combination with the vehicle data 202 during the coastdown procedure 210. Thus, the service perimeter 216a defined by the controller 200 may shift or be recalibrated depending on the sensor data 104, the vehicle data 202, and the GPS data 302.

The controller 200 may direct the vehicle 10 to the service perimeter 216a in response to the trigger event 106, which initiates the coastdown procedure 210. The trigger event 106 corresponds to a loss of propulsion 106a of the vehicle 10, such that the coastdown procedure 210 is initiated to bring the vehicle 10 to a stop in response to the loss of propulsion 106a. The controller 200 executes a trigger event evaluation 220 during which the controller 200 determines a severity level 222 of the trigger event 106. In response to the trigger event 106, the controller 200 initiates the coastdown procedure and, based on the trigger event evaluation 220, determines an available coastdown range 224 that the vehicle 10 may travel during the coastdown procedure 210.

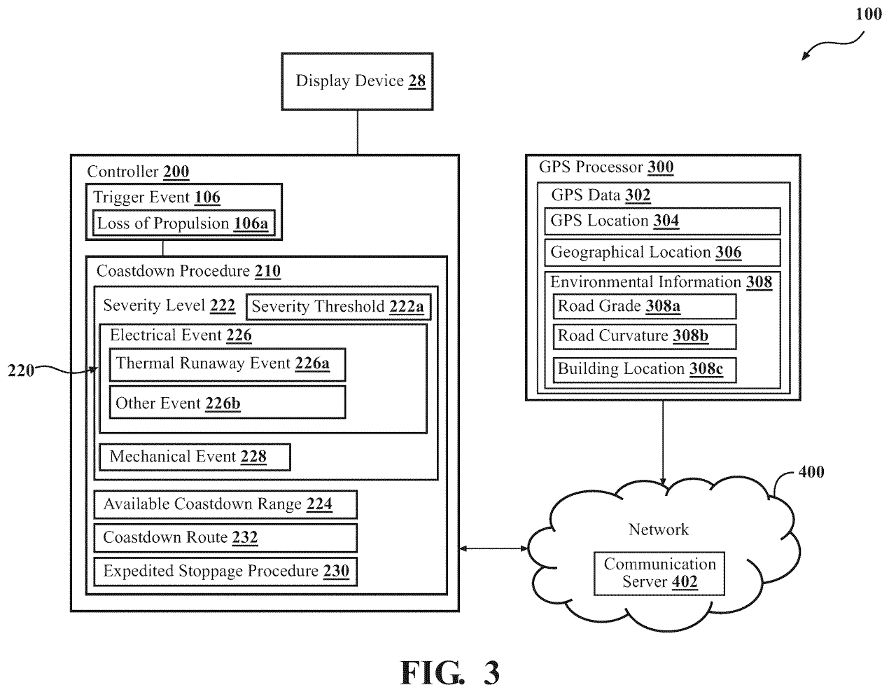

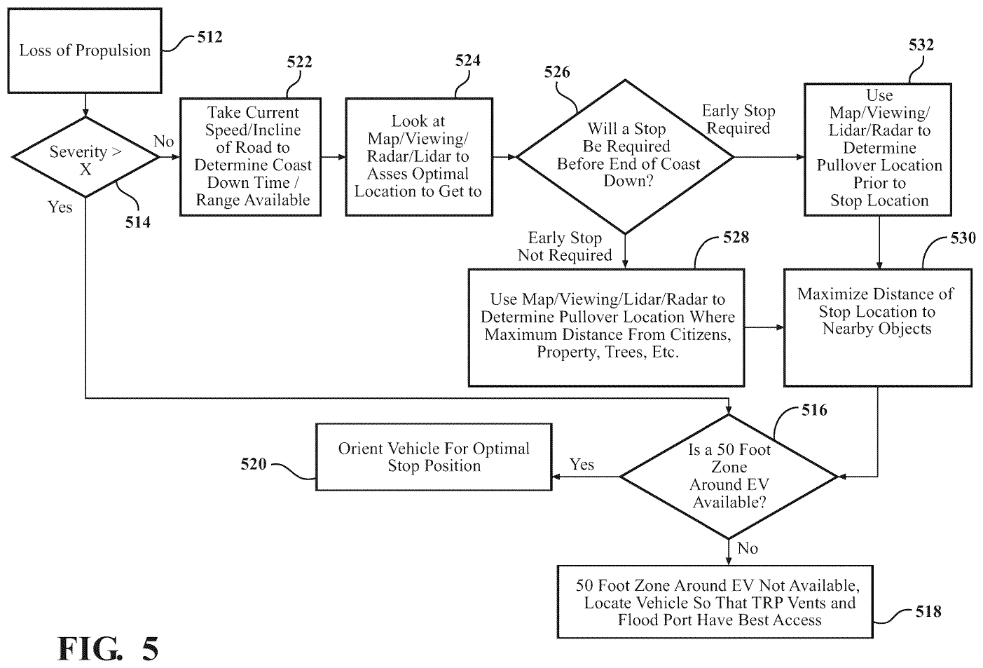

With specific reference to FIG. 3, the severity level 222 determination includes an identification of the trigger event 106 as one or more of an electrical event 226 and a mechanical event 228 triggered as a result of a loss of propulsion 106a. The electrical event 226 may include a thermal runaway event 226a, which would result in the controller 200 executing an expedited stoppage procedure 230. The thermal runaway event 226a is categorized by a battery of the vehicle 10 entering a self-heating state, such that an accelerated battery temperature releases energy that continuously increases the temperature of the battery. In the event that the trigger event 106 is a thermal runaway event 226a, the coastdown procedure 210 will notify the controller 200 of immediate attention and recommend the expedited stoppage procedure 230. In response, the controller 200 will identify the pull-over location 216 and notify the occupant that the coastdown procedure 210 is in effect. The controller 200 will recalibrate the service perimeter 216a based on the expedited stoppage procedure 230 in response to the thermal runaway event 226a in order to reach the stop position 212 at an increased rate as compared to a trigger event 106 with a lesser degree of severity. The coastdown procedure 210 and methods of operation are described in more detail below with respect to FIGS. 5-7.

While the thermal runaway event 226a is one potential electrical event 226 that may trigger the coastdown procedure 210, other electrical events 226b may also trigger the coastdown procedure 210. The trigger event 106 may also include the mechanical event 228 to similarly trigger the coastdown procedure 210. The mechanical events 228 may include, but are not limited to, a gasket failure, a loss of tire pressure, and other mechanical events that may result in a loss of propulsion 106a. When such mechanical events 228 are identified, the controller 200 may determine it is advantageous to minimize extended drivability. While the mechanical events 228 may result in activation of the coastdown procedure 210, it is generally contemplated that the mechanical events 228 have a lower severity level 222 as compared to the electrical events 226. In some aspects, the thermal runaway event 226a may have the highest severity level 222. Given the high severity level of the thermal runaway event 226a as compared to other trigger events 106, it is contemplated that the coastdown procedure 210 be configured with a severity threshold 222a. The controller 200 is configured to use the severity threshold 222a to determine the subsequent execution of the coastdown procedure 210.

The severity level 222 of the trigger event 106 determines the output of the coastdown procedure 210 as executed by the controller 200. For example, where the trigger event 106 has a low severity level 222, the available coastdown range 224 for the vehicle 10 to reach the stop position 212 may be greater than the available coastdown range 224 during the thermal runaway event 226a. Thus, the controller 200 may adjust the stop position 212 based on the severity level 222. The coastdown procedure 210 is further configured to account for the environmental information 308 from the GPS data 302, such that the controller 200 may account for the environmental information 308 when determining the available coastdown range 224.

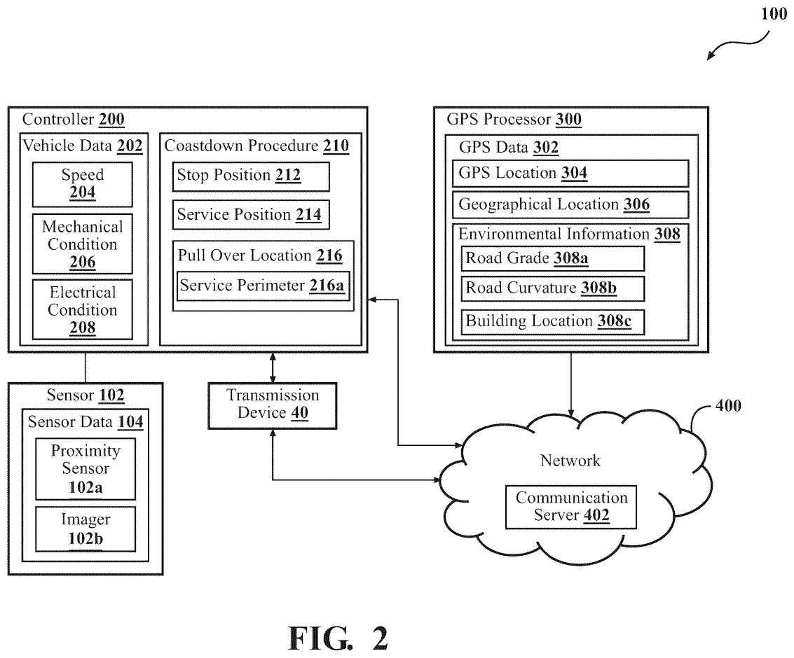

With reference to FIGS. 2 and 3, the controller 200 may determine a coastdown route 232 of the coastdown procedure 210 based on the vehicle data 202, the GPS data 302, and the trigger event 106. The coastdown route 232 is a fluid route in that the controller 200 may actively update the coastdown route 232 during execution of the coastdown procedure 210 to maximize the available coastdown range 224 relative to an optimized service perimeter 216a. For example, the controller 200 may receive environmental information 308 relating to the road grade 308a indicating that an alternate route may utilize adjacent declines in the road to advance the vehicle 10 along the coastdown route 232 without utilizing additional propulsion techniques. Stated differently, the vehicle 10 may utilize the road grade 308a to coast along the coastdown route 232 toward the service perimeter 216a and into the stop position 212. Additionally or alternatively, the environmental information 308 may indicate a road curvature 308b that may assist in the progression of the vehicle 10 along the coastdown route 232 during the coastdown procedure 210.

Once the vehicle 10 is approaching the service perimeter 216a, the controller 200 may determine the stop position 212 and/or the service position 214 based on building locations 308c and other obstructions that may be present in the service perimeter 216a. As described in more detail below; the controller 200 gathers the sensor data 104 pertaining to the service perimeter 216a from the sensors 102 positioned along the vehicle 10. While the service perimeter 216a may be initially identified by the controller 200 based on the GPS data 302, the controller 200 may refine the location of the service perimeter 216a as the vehicle 10 approaches the service perimeter 216a. The refinement occurs as a result of the sensor data 104 captured by the sensors 102 and communicated to the controller 200 to optimize the position of the vehicle 10. While the position optimization may include determining the service position 214 relative to the vehicle environment, as noted above, when there is a trigger event 106 with a high severity level 222 (e.g., a thermal runaway event 226a), the service perimeter 216a may be identified as an area in close proximity that is spaced a reasonable distance away from obstructions 50 and surrounding traffic.

With specific reference to FIG. 5, a flow diagram illustrating the operation of the coastdown procedure 210 is depicted. Initially, at 510, a trigger event 106 (e.g., a loss of propulsion 106a) is detected. The controller 200 determines, at 512, whether a severity level 222 of the trigger event 106 exceeds the severity threshold 224a. If the trigger event 106 exceeds the severity threshold 224a, then the controller 200, at 514, immediately identifies whether the service perimeter 216a is available. If the service perimeter 216a is not available, the controller 200, at 516, orients the vehicle 10 in a stop position 212. In the stop position 212, the vehicle 10 may be positioned to maximize access to the service port 24 to the degree that a service provider 60 (FIG. 9) may at least partially access the service port 24 from the stop position 212.

It is generally contemplated that the stop position 212 of the vehicle 10, at 516, is less than the predetermined distance D₂₁₆ from surrounding obstructions 50, such that while the service port 24 may be generally accessible in the stop position 212, the service port 24 may be at least partially obstructed. If the service perimeter 216a is available, the controller 200, at 520, orients the vehicle 10 in a service position 214. In the service position 214, the vehicle 10 is positioned at least the predetermined distance D₂₁₆ away from the surrounding obstructions 50 with the service port 24 fully accessible to a service provider 60. It is also contemplated that, in the service position 214, the vehicle 10 is positioned to be received on a bed 62 (FIG. 9) of the service vehicle 60 or may otherwise be accessible for removal from the service position 214 by the service provider 60 after execution of the coastdown procedure 210.

If the trigger event 106 does not exceed the severity threshold 224a, then the controller 200, at 522, evaluates the GPS data 302 to determine an available coastdown range 224 of the coastdown procedure 210. For example, the controller 200 may assess the vehicle data 202 in combination with the environmental information 308 from the GPS processor 300, such as the road grade 308a, to identify the available coastdown range 224 to a service perimeter 216a. Once the available coastdown range 224 is identified by the controller 200, then, at 524, the controller 200 evaluates the geographical location 304 to assess an optimal location for the service perimeter 216a. Once the controller 200 identifies the optimal service perimeter 216a, the controller 200, at 526, determines whether any traffic patterns, including but not limited to, intersections, traffic, and traffic lights, will impact the coastdown route 232.

If the controller 200 determines the coastdown route 232 will be impeded, then the controller 200, at 528, utilizes the GPS data 302 and sensor data 104 to determine a pull-over location 216. The pull-over location 216 is generally positioned at a location spaced apart from surrounding traffic, pedestrians, and other obstructions 50 that may be proximate to the vehicle 10. The controller 200, at 530, then identifies a predetermined distance D₂₁₆ between the vehicle 10 and surrounding obstructions 50 and, at 516, determines whether the vehicle 10 may be positioned at least the predetermined distance D₂₁₆ away from the obstructions 50. The determination of whether the vehicle 10 may be positioned at least the predetermined distance D₂₁₆ away from the obstructions 50 results in the controller 200 executing one of the steps 520 or 518, as described above.

Referring back to step 526, when the controller is determining whether the coastdown route 232 will be affected by traffic patterns, the controller 200 may determine that the traffic pattern may impact the coastdown route 232, such that the controller, at 532, identifies the pull-over location 216, which may be at a location prior to the previously identified service perimeter 216a for the stop position 212 or the service position 214. After adjustment for the early stop, the controller 200 may execute the subsequent steps of 530, 516, and one of 518 or 520.

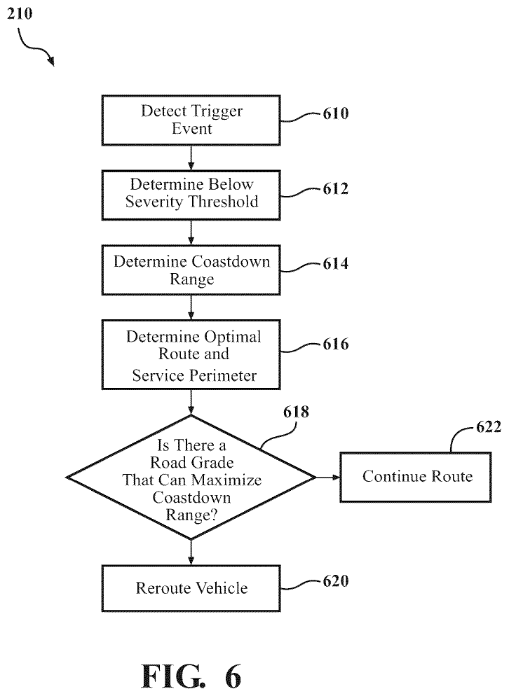

With the specific reference to FIG. 6, the coastdown procedure 210 is outlined with respect to the coastdown route 232 and stoppage procedure 230. At 610, the controller 200 detects a trigger event 106 and determines, at 612, whether the trigger event 106 is below a severity threshold 224a. Depending on the severity level 222, at 616, the controller 200 determines the available coastdown range 224, and at 618, determines the optimal coastdown route 232 and corresponding service perimeter 216a. At 620, the controller 200 may utilize GPS data 302 from the GPS processor 300 to determine whether there is an available road grade 308a that may maximize the coastdown range 224. If there is an available road grade 308a that may maximize the available coastdown range 224, then the controller 200, at 620, may reroute the vehicle 10 onto the coastdown route 232 including the road grade 308a. If there is no available road grade 308a to maximize the coastdown range 224, then the controller 200, at 622, will continue the coastdown route 232. It is generally contemplated that the controller 200 may continuously survey the GPS data 302 to identify whether any environmental information 308 may maximize the available coastdown range 224 and may adjust the coastdown route 232 accordingly.

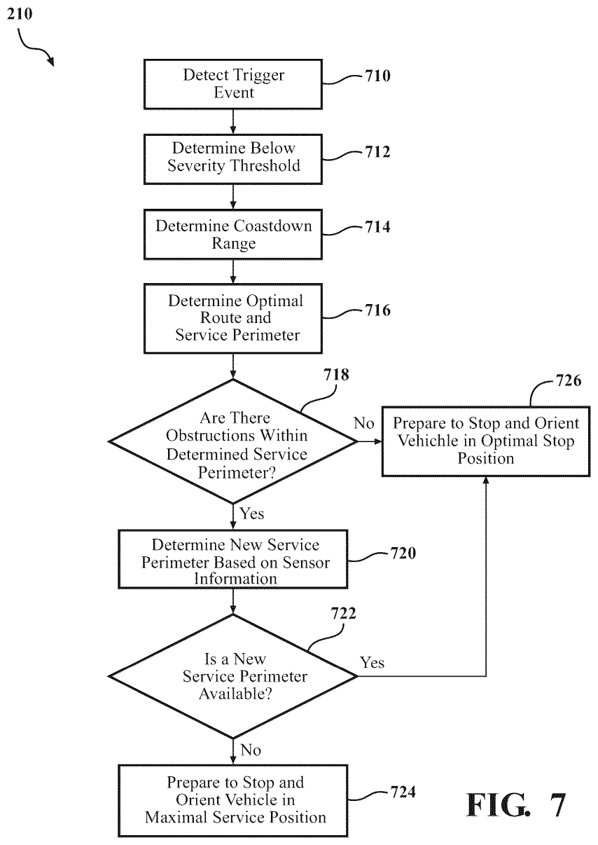

With specific reference now to FIG. 7, another aspect of the coastdown procedure 210 is outlined. At 710, the controller 200 detects a trigger event 106 and determines, at 712, whether the trigger event 106 is below a severity threshold 224a. The controller 200, at 714, then determines available coastdown range 224 and subsequently, at 716, determines a coastdown route 232 and service perimeter 216a. As the vehicle 10 approaches the service perimeter 216a, the controller 200, at 718, determines whether there are any obstructions 50) within the service perimeter 216a. If there is an obstruction 50 within the service perimeter 216a, the controller 200, at 720, determines a new service perimeter 216a based on sensor data 104 obtained from sensors 102 disposed on the vehicle 10. The controller 200, at 722, then determines whether a new service perimeter 216a is available. If no new service perimeter 216a is available, the controller 200, at 724, prepares to orient the vehicle 10 in the stop position 212 and, if possible, in the service position 214. If there are no obstructions 50 within the determined service perimeter 216a, the controller 200, at 726, prepares a stoppage procedure 230 to orient the vehicle 10 in the service position 214 within the service perimeter 216a.

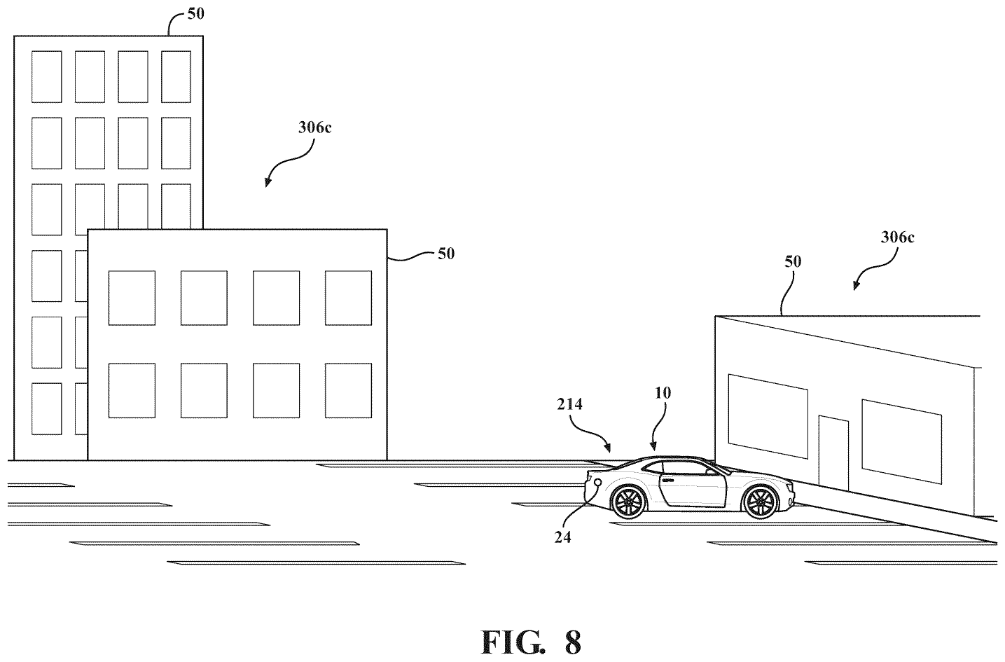

Referring again to FIGS. 1A-9, the vehicle assist system 100 assists the vehicle 10 in reaching a final position in which the occupant may safely exit the vehicle 10 and contact a service provider. The coastdown procedure 210, via the controller 200, determines the optimal coastdown route 232 based on the available coastdown range 224 and GPS data 302. Thus, the occupant may be alerted to the coastdown procedure 210 being triggered as a result of the trigger event 106, and the coastdown procedure 210 will proceed to navigate the vehicle 10 to at least one of the stop position 212 and the service position 214. It is also contemplated that the controller 200 may alert a service provider using the transmission device 40 in combination with the communication server 402 of the network that the coastdown procedure 210 has been triggered. The communication server 402 may provide feedback to the occupant via the transmission device 40 notifying the occupant that a service provider will meet them at the pull-over location 216. Thus, the coastdown procedure 210 advantageously assists occupants when the vehicle 10 is in a service state as a result of a trigger event 106.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An assist system for a vehicle, the assist system comprising:
a sensor coupled to a body of the vehicle and configured to detect objects within an environment proximate to the vehicle;
a GPS processor configured to communicate a geographical location of the vehicle:
a controller communicatively coupled to the sensor and the GPS processor and storing vehicle data and a coastdown procedure including a stop position, a service position, and a service perimeter, the controller being configured to receive a signal from the sensor corresponding to a trigger event and to execute, in response to the trigger event, the coastdown procedure based on the vehicle data; and
a communication server communicatively coupled to the controller via a network, the controller configured to send a signal to the communication server in response to the trigger event, the communication server being configured to communicate the coastdown procedure with an occupant of the vehicle.

2. The assist system of claim 1, further including a display device communicatively coupled to the controller, the controller being configured to display the coastdown procedure on the display device.

3. The assist system of claim 1, wherein the coastdown procedure includes an available coastdown range of the vehicle.

4. The assist system of claim 1, wherein the controller is configured to identify the trigger event as at least one of an electrical event and a mechanical event, the electrical event including a thermal runaway event.

5. The assist system of claim 1, wherein the controller is configured to route the vehicle to the stop position and the service position within the service perimeter.

6. The assist system of claim 5, wherein the GPS processor stores environmental information including road grade, road curvature, and building locations.

7. The assist system of claim 6, wherein the controller is configured to adjust the coastdown procedure in response to the environmental information received from the GPS processor.

8. The assist system of claim 1, wherein the sensor includes at least one of an imager, a proximity sensor, and a LIDAR sensor.

9. A vehicle assist system comprising:
an imager coupled to a vehicle body and being configured to capture a vehicle environment;
a GPS processor configured to detect a geographical location of a vehicle; and
a controller storing vehicle data and a coastdown procedure and communicatively coupled to the imager and the GPS processor, the controller being configured to detect a trigger event and to execute, in response to the trigger event, the coastdown procedure based on the vehicle data, the vehicle environment from the imager, and the geographical location of the vehicle.

10. The vehicle assist system of claim 9, wherein the coastdown procedure includes a stop position, a service position, and a service perimeter, the controller being configured to identify the service perimeter based on the geographical location of the vehicle and the vehicle environment.

11. The vehicle assist system of claim 10, wherein the GPS processor stores environmental information including road grade, road curvature, and building locations, the controller being configured to determine a coastdown range based on the environmental information from the GPS processor.

12. The vehicle assist system of claim 11, wherein the controller is configured to update the coastdown procedure based on building locations received from the GPS processor.

13. The vehicle assist system of claim 10, wherein the controller is configured to receive the vehicle environment from the imager and is configured to adjust the coastdown procedure in response to the vehicle environment.

14. The vehicle assist system of claim 11, wherein the controller is configured to reroute the vehicle during the coastdown procedure to maximize a coastdown range in response to the road grade.

15. The vehicle assist system of claim 9, further including a communication server communicatively coupled to the controller via a network, the controller being configured to send a signal to the communication server in response to the trigger event and the communication server configured to communicate the coastdown procedure with an occupant.

16. An assist system for a vehicle, the assist system comprising:
an imager coupled to a body of the vehicle and being configured to capture a vehicle environment;
a GPS processor configured to detect a geographical location of the vehicle and store environmental information including road grade and road curvature; and
a controller communicatively coupled to the imager and the GPS processor and being configured to determine a coastdown route and a service perimeter based on the vehicle environment received from the imager and the environmental information received from the GPS processor in response to a trigger event detected by the imager.

17. The assist system of claim 16, wherein the controller is configured to adjust the coastdown route based on sensor data from the imager and GPS data from the GPS processor.

18. The assist system of claim 16, further comprising a service port, the controller being configured to define the service perimeter of the coastdown procedure based on a location of the service port.

19. The assist system of claim 18, wherein the coastdown procedure stores a service position defined as the service port being free from obstructions.

20. The assist system of claim 16, wherein the trigger event is a loss of propulsion.
